(19) United States
(12) Patent Application Publication
(10) Pub. No.: US 2004/0111304 A1
(43) Pub. Date: Jun. 10, 2004

(54) System and method for supply chain aggregation and web services

(75) Inventors: Sekar Meka, Livermore, CA (US); Umeshchandra H. Patel, Santa Clara, CA (US)

Correspondence Address: FREDERICK W. GIBB, III, MCGINN & GIBB, PLLC, 2568-A RIVA ROAD, SUITE 304, ANNAPOLIS, MD, 21401, US

(73) Assignee: International Business Machines Corporation, Armonk, NY (US)

(21) Appl. No.: 10/309,447

(22) Filed: Dec. 4, 2002

(51) Int. Cl. G06F 17/60

(52) U.S. Cl. 705/7

(57) ABSTRACT

An information management system configured to integrate a one-to-many business process interaction using on-demand supply chain management among enterprises who are customers of and suppliers to eachother comprises an entitlement engine, a web service aggregator, and a private exchange network operable to link the entitlement engine with the web service aggregator. The entitlement engine comprises a relational entitlement component, a pass-thru entitlement component, and a resource entitlement component, wherein the relational entitlement component parses data based on a predefined business process among the enterprises, wherein the pass-thru entitlement component parses data from one enterprise up to an n number of enterprises, and wherein the resource entitlement component parses data based on available resources of the enterprises. The web service aggregator comprises rules, which are maintained in the private exchange network.

### BACKGROUND OF THE INVENTION

1. Field of the Invention

The present invention generally relates to integrated information exchange, and more particularly to a system and method for web based supply chain management and web services implemented in a private exchange and resulting in a reduction in fulfillment lead times.

2. Description of the Related Art

While economic periods of growth and slow down fade in and out in a cyclic manner, evolving business models and technologies have not enabled enterprises large and small to improvise supply chain management effectively. During a downturn period in an economic cycle, virtually no enterprise is able to avoid inventory glut. Two common business problems, particularly in the technology sector are (1) longer sales cycle resulting in higher cost of sales; and (2) excess inventory. In an effort to overcome these problems, conventional approaches develop and utilize sophisticated enterprise resource planning (ERP) and supply chain management (SCM) type solutions. However, despite these advanced approaches, most corporations continue to struggle to survive periods of economic downturn.

Although enterprises have colossal information in their ERP and SCM applications, these enterprises have been unable to comprehend the waves of both the over and the under supply. Moreover, an enterprise's ability to execute impeccably in all types of economic environments lies in their ability to grasp existing, as well as forthcoming market conditions to optimize their supply chain. Some enterprises decide to micro-manage demand management by pulling in the planning horizon to less than one month. This approach is flawed as the business environment remains unpredictable and the customer outlook and order forecasts remain unreliable as well.

Conventionally, “just-in-time” (JIT) inventory management systems cannot withstand the litmus test when supply exceeds demand. Usually, the upstream supply chain partners inherit the responsibility of managing component supplies and the inherent risks associated with it as well. Unfortunately, with the contemporary supply chain practices, most of the supply chain partners are left lamenting about the inventory glut.

The networking equipment industry currently uses a semi on-demand order fulfillment called build-to-order. However, these systems do not provide an integrated view of the component supply in the upstream of the supply chain. To better understand the on-demand model, the networking equipment industry is offered as an example, which includes the original equipment manufacturers (OEM) such as Cisco, Lucent, Nortel and others; engineering management services (EMS) partners such as Solectron, Celestica and others; and component makers such as IBM, JDS Uniphase, Coming and others; and of course the channel.

Traditionally, the OEMs outsourced manufacturing, component supply management, and in some cases, engineering services as well to EMS partners with long term agreements. The challenge is that during a period with very strong demand, EMS partners may have an average component supply of 60 days, which is much higher than the typical industry average. This has a profound impact on their bottom line, usually in billions of dollars especially when components have a very short shelf life due to rapid technological advances and obsolescence. The rest of the supply chain partners are similarly challenged with the same scenario. In their pursuit of increasing market share and capturing new markets during high growth times, OEMs amplify their forecasts for demand, which permeates to EMS partners and further into the upstream supply chain. The disconcerted outcome is always an inventory glut. This challenge needs to be overcome in the entire supply chain including the upstream partners. Therefore, there is a need for an innovative supply chain management system and method, which is on-demand centric.

### SUMMARY OF THE INVENTION

The present invention has been devised to provide a system and method for internet based supply chain management and web services implemented in a private exchange and resulting in a reduction in fulfillment lead times.

There is provided, according to one aspect of the invention an information management system configured to integrate a one-to-many business process interaction using on-demand supply chain management among enterprises who are customers of and suppliers to each other comprises an entitlement engine, a web service aggregator, and a private exchange network operable to link the entitlement engine with the web service aggregator. The entitlement engine comprises a relational entitlement component, a pass-thru entitlement component, and a resource entitlement component, wherein the relational entitlement component parses data based on a predefined business process among the enterprises, wherein the pass-thru entitlement component parses data from one enterprise up to an n number of enterprises, wherein the resource entitlement component parses data based on available resources of the enterprises, and wherein each of the pass-thru entitlement and resource entitlement components are linked to the relational entitlement component. Furthermore, the web service aggregator comprises rules, which are maintained in the private exchange network.

The system further comprises a core module, which comprises the entitlement engine; a communication module, which comprises the web services aggregator; a data management module linked to the core module; a transaction module linked to the core module; a service management module linked to the core module; and a database cluster linked to the data management module. The data management module comprises a data mapping and transformation component linked to the database cluster; a cache manager linked to the database cluster; and a broadcast manager linked to the communication module.

The core module further comprises an enterprise interaction rules engine linked to the database cluster; a business alert manager linked to the database cluster; and an event flow manager linked to the enterprise interaction rules engine. The service management module further comprises a billing manager linked to the database cluster; and an entitlement manager linked to the database cluster, wherein the billing manager communicates with an external billing system. The transaction module further comprises a transaction audit component linked to the core module; and a persistence manager linked to the core module.

The present invention also provides a method for managing a one-to-many business process interaction using an on-demand supply chain management system among enterprises who are customers of and suppliers to each other, wherein the method comprises making requests for services on a web-based network to one or more enterprises, accessing the web-based network services by other enterprises in accordance with a predefined relationship through a private exchange system, and fulfilling the requests by one or more of the enterprises using the on-demand supply chain management system. The on-demand supply chain management system of the present invention is operable through an entitlement engine having a relational entitlement component, a pass-thru entitlement component, and a resource entitlement component, which are linked to one another.

There are several advantages of the present invention. Particularly, this type of on-demand supply chain management system is applicable to the entire supply chain, and it supports reduction in fulfillment lead times from several weeks down to a few days (more than 50%) as it is not necessary to locate component suppliers. The present invention also enhances supply-chain visibility and spot-pricing in the field, as well as providing price protection for products with declining average selling price and shorter product life. Furthermore, the present invention provides price determination closer to delivery schedule, and provides normalization of demand and capacity without requiring over investments to increase the merely short-lived capacity demand.

### BRIEF DESCRIPTION OF THE DRAWINGS

The foregoing and other objects, aspects and advantages will be better understood from the following detailed description of a preferred embodiment(s) of the invention with reference to the drawings, in which:

FIG. 1 is a system diagram illustrating a preferred embodiment of the present invention;

FIG. 2 is a system diagram illustrating a preferred embodiment of the present invention;

FIG. 3 is a system diagram illustrating a preferred embodiment of the present invention;

FIG. 4 is a flow diagram illustrating a preferred method of the invention; and

FIG. 5 is a system diagram according to the present invention.

### DETAILED DESCRIPTION OF PREFERRED EMBODIMENTS OF THE INVENTION

As mentioned there is a need for an innovative supply chain management system and method, which is on-demand centric. The present invention addresses this need by providing a supply chain management system implemented with web services.

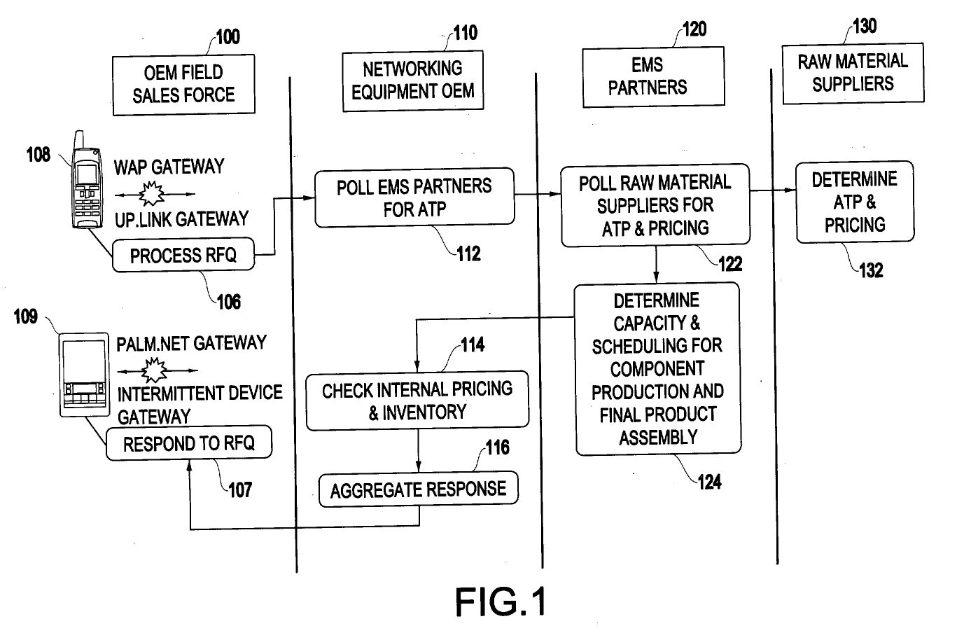

Referring now to the drawings, and more particularly to FIGS. 1 through 5, there are shown preferred embodiments of the method and structures according to the present invention. The present invention overcomes the business problems discussed above using a fused business-technology solution for on-demand value chain aggregation. Accordingly, the present invention provides two means by which the entire supply chain could enhance their ability to maintain equilibrium in the supply chain during both the slow and the fast growth periods of the economy

The first approach is classified as EMS centric. Here, the EMS partners retain existing capabilities but do not maintain or manage component supplies. Moreover, the EMS capacity would not be a challenge because even during the periods of high growth and demand, EMS partners utilize approximately 95% of their collective capacity. This aligns perfectly with the on-demand model. Hence, the EMS capacity is a commodity.

This approach is further illustrated in FIG. 1, whereby when the channel or the OEM 110 identifies a demand, multiple component suppliers are evaluated for price, availability and quality. There is an inherent assumption that the role of an OEM sales person 100 and supply-demand planning personnel will be transformed so that there is more consolidation of responsibilities yielding better supply chain planning and execution. Also, the underlying premise is that suppliers 130 are pre-qualified for interoperability, technical characteristics, reliability, etc. Once the knowledge of the component supplier 130 is established, multiple EMS partners 120 are evaluated for capacity scheduling. Therein, when EMS scheduling possibilities are known, the OEM firms up component supply and EMS scheduling and the order is confirmed with the customer or channel.

Here, the OEM 100 receives a request for quote (RFQ) 106 from the OEM field sales force 100, and begins to request 112 its EMS partners 120 ATP (Available to Promise) determination. Subsequently, the EMS partners 120 request 122 its raw material suppliers 130 for ATP and pricing. Once, the raw material suppliers 130 determine 132 the ATP and pricing, the EMS partners 120 determine 124 the capacity and scheduling for component production and final product assembly. This information is then passed back to the OEM 110, who then check 114 their internal pricing and inventory and aggregate 116 a response based on its data. This response is then submitted back to the OEM field sales force 100, as the RFQ has been fulfilled 107. Communication gateways 108, 109 are used by the OEM field sales force 100 to communicate and process its RFQs.

In this scenario the EMS partner 120 does not maintain or manage component supplies, as the responsibility of managing component supplies shifts to the OEMs 110. The EMS partners 120 and the OEMs 110 can shirk inventory glut as neither maintains any inventory. However, one of the variable component supplies may impact order lead times and pricing. For the networking equipment sector, the average number of days of component supply on-hand could be close to 10 days, which is well below the industry average of 45 days and much less than 60 days, which is common in down economic cycles. Therefore, the first approach is a preferred scenario, as it provides price protection to both the OEM and the channel while reducing the cost of sales by more than 50%.

In a second alternative approach, identified as EMS and Component Supplier Centric, wherein the EMS capacity and components are commodities, the EMS partners would not only manufacture or assemble products for the OEM customers, but also take on manufacturing of the components used as well, which is a consolidated service for both upstream and downstream supply chain partners. The on-demand requirements would then permeate upstream in the supply chain and the only inventory needed would be the raw materials for components which would be physically stored in the vicinity of EMS facilities from where they can be pulled just-in-time. All of the assumptions made in the first scenario hold equally true in this scenario as well.

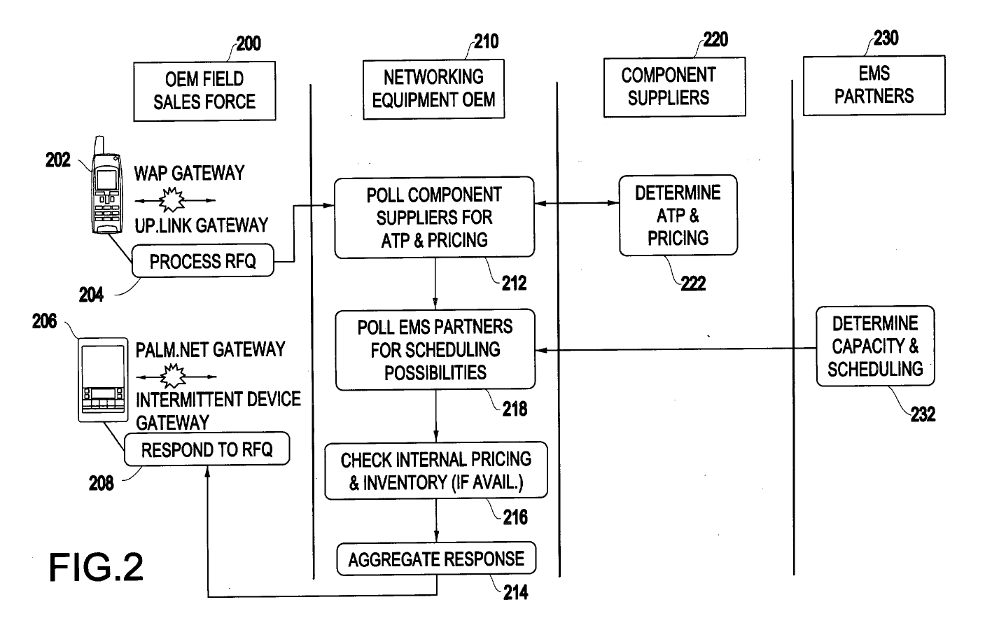

FIG. 2 illustrates the second scenario, and uses, as an example, the situation where a networking equipment manufacturer OEM 210 receives a RFQ for a networking switch or a router. The networking equipment manufacturer OEM 210 would then evaluate multiple EMS partners 230 for their capacity and scheduling possibilities to build the components and build/assemble finished goods. Then, based on the collective knowledge of the possibilities for EMS scheduling to build components (including availability of raw-materials) and finished products, a super production plan would be developed and shared across with the upstream supply chain partners. Once the components are manufactured or fabricated, finished products would be produced and shipped directly to the OEM 210, channel partner or end customer.

In this second scenario both the EMS capacity and component are considered commodities, which can be requested on-demand with some lead-time contingent on raw materials for the components and the EMS schedule. The attractiveness of this model is that there is no inventory accumulation during periods with both high and low demand for products except for the raw materials. The multiple dependencies on the supply side are minimized by fewer disjoints in the supply chain; that is, fewer partner dependencies.

More specifically, the OEM 210 receives a RFQ 204 from the OEM field sales force 200, and begins to request 212 the component suppliers 220 for ATP and price determination. Once, this determination is made and the information is sent back to the OEM 210, the OEM 210 request 214 scheduling possibilities from its EMS partners 230, who then determine 232 the capacity and scheduling. This information is then passed back to the OEM 210, who then check 216 their internal pricing and inventory and aggregate 216 a response based on its data. This response is then submitted back to the OEM field sales force 200, as the RFQ has been fulfilled 208. Communication gateways 202, 206 are used by the OEM field sales force 200 to communicate and process its RFQs.

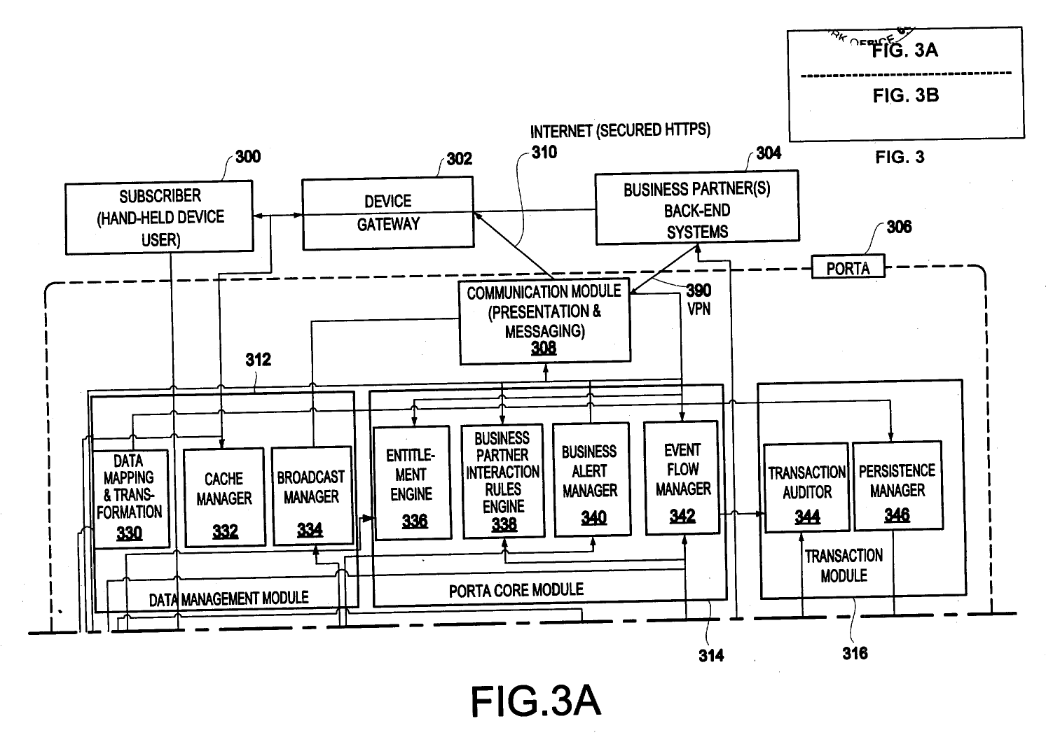

The present invention, which provides a design for web services and facilitates the interaction between various business partners through a private exchange, comprises two parts. The first part is a Tiered Web Services component having the ability to aggregate interaction, and the second part is a three-way Entitlement Engine. The architecture of the present invention is depicted in FIG. 3, wherein the several components are shown. Essentially, the architecture comprises several modules operatively connected to one another. These modules include a Communication Module 308, a Data Management Module 312, a Porta Core Module 314, a Transaction Module 316, and a Service Management Module 318.

The Data Management Module 312 comprises a Data Mapping and Transformation component 330 linked to the database cluster 320, a Cache Manager 332 linked to the Database Cluster 320, and a Broadcast Manager 334 linked to the Communication Module 308. The Porta Core Module 314 comprises the Entitlement Engine 336 linked to the Database Cluster 320, a Business Partner (Enterprise) Interaction Rules Engine 338 linked to the Database Cluster 320, a Business Alert Manager component 340 linked to the Database Cluster 320, and an Event Flow Manager 342 linked to the Enterprise Interaction Rules Engine 338.

The Service Management Module further comprises a Billing Manager 348 linked to the Database Cluster 320, and an Entitlement Manager 350 linked to the Database Cluster 320, wherein the Billing Manager 348 communicates with an external Billing System, 380, such as a SAP™ billing system, available from SAP, PA, USA. The Transaction Module 316 further comprises a Transaction Auditor component 344 linked to the Porta Core Module 314, and a Persistence Manager 346 linked to the Core Module 314.

The Business Partner Interaction Rules Engine 338 is essentially the “brain” behind the Porta 306. The Rules Engine 338 has the intelligence to facilitate the various business partners and subscribers to interact in the context of the business domain. Its operations and functioning are in the realm of Artificial Intelligence. The Rules Engine 338 hosts the rules for the interaction between trusted Business Partners 304, it hosts a run time engine to invoke the pertinent rules stored when a Subscriber 300 initiates a transaction, it harbors the aggregation rules and executes them in an appropriate sequence on obtaining responses from multiple Business Partners 304 in response to a single query, and it controls and executes invocation of rules and associated transactions in accordance with a Porta predefined paradigm.

The Event Flow Manager 342 functions as the “spinal chord” of the Porta 306. The Event Flow Manager 342 is a very innovative technical component conceived with characteristics such as real time response, event co-ordination, event queuing, event dependency and contingency. The Event Flow Manager 342 coordinates the information flow based on requests from various components of the Porta 306. It also polls on multiple responses for a single query and forwards the responses to the Business Partners Interaction Rules Engine 338 for processing. The Event Flow Manager 342 also manages timeout, re-submission and recovery of transactions, and issues messages to the Broadcast Manager 334, Business Alert Manager 340, Transaction Auditor 344, and the Transit Manager 316 (also referred to as the Transaction Module) for transaction recovery.

The Entitlement Engine 336 sits at the core of the security system of the Porta 306. The Entitlement Engine 336 is a very fast response piece of machinery as it is a “gate keeper” on the information conduit between the clients and the back-end systems 304 holding vital information. Essentially, it has to “clear” every transaction being carried out on the Porta 306. The Entitlement Engine 336 facilitates a high level of secure access control to various business activities in the Porta domain 306. Entitlement (to data) can be granted at an organization level or at an individual level within an organization, subscribing organization, or Subscriber 300 within an organization, wherein the entitlements can be at the level of business activity in the Porta 306 or to a very fine level of information resource, such as a part number, thereby supporting high level of granularity. Moreover, the Entitlement Engine 336 accommodates varying information resource assets, and accesses control restrictions in various business scenarios.

The Communication Module 308 hosts a channel translator to perform the translation between XML, WML, HTML, HDML, and BLOB data formats. It also hosts a presentation manager, which presents XML content using XSL. Moreover, the Communication Module 308 manages all adapters providing process-based interaction between various component modules of the Porta 306 and with the Business Partner's Back-End Enterprise Systems 304 (CRM, ERP, SFA, SCM type applications). This process-based interaction between the Communication Module 308 and the partner's Back-End Systems 304 occurs over a VPN (Virtual Private Network) 390, which facilitates a secured interaction communication network. The Business Partner's Back-End Systems 304 hosts business partner facing processes (supporting CRM, SCM, etc.,) with which Subscribers 300 are authorized to interact with through a Device Gateway 302, which also communicates with the Communication Module through a secured Internet 310 having secured HTTPS (HyperText Transfer Protocols). The Device Gateway 302, which is provided by wireless carriers, facilitates end-to-end communications.

The Persistence Manager 346 provides the ability to resume transaction(s), which were previously aborted due to any reason including but not limited to loss in communication between the Subscriber 300 and the Porta 306 or a general system failure. The Persistence Manager 346 preserves the state of the transaction where it was aborted so a Subscriber 300 can resume the transaction without having to reenter all of the transaction details again. It also guarantees that the transaction posting happens only once without loss of the transaction.

The Business Alert Manager 340 alerts the field service personnel with key critical information of an enterprise, its business activity or business partners, which may be related to customer service, orders, inventory, quotes, pricing change, etc. Additionally, the Business Alert Manager 340 processes special campaigns released by an enterprise.

The Transit Manager 316 allows for a fast transfer of the current transactions in progress to cache. It allows the transfer from cache to backup, in the event of a loss of connection, and allows resumption of transactions when a prior connection is interrupted or lost. Moreover, the Transit Manager 316 associates transit data with recovery of interrupted transactions.

The Data Mapping and Transformation 330 component of the Porta 306 is a sub-module, which is responsible for the data mapping and transformation both for the incoming and outgoing information at the entry/exit point of the Porta 306. The Data Transformation module 330 maps or derives the aggregated information across Business Partners 304 and Subscribers 300 according to certain rules and formats. The Business Partner's master data mapping is stored in the Master Data tables 364.

The Cache Manager 332 facilitates a quick look up of the frequently required data without going to back-end enterprise application systems thereby enabling a faster response. Moreover, the data stored in the Cache Manager 312 is often used data by the Porta 306 and is identified by an “intelligent agent” based on a stochastic model.

The Broadcast Manager 334 broadcasts to the Subscribers 300 pertinent information based on the subscription and business rules, and informs the Billing Manager 348 of the subscriptions (periodic and event-based broadcast for billing purposes). Moreover, the Broadcast Manager 334 is a high tech module and resorts to multi-casting to reduce network traffic.

The Transaction Auditor 344 records characteristics of every transaction in Porta 306, and provides a statistical analysis of the log for input to reports, billing, etc. The Entitlement Manager 350 provides a GUI (graphic user interface) for administering entitlements for Business Partners 354, Subscribers 356 and Porta Administrators 358, which communicate with Porta Administrator Systems 352. Moreover, the Entitlement Manager 350 can halt or suspend entitlements whenever necessary, and whatever the circumstance, thereby enforcing security, even on short notice.

The Billing Manager 348 facilitates a consolidated billing system 380 for the services rendered by the Porta 306 to Subscribers 300 on behalf of downstream supply-chain business partners, and for internal use by Business Partners 304, based on their activities. The billing protocol would essentially contain a base service price and an additional service access fee.

Various database tables are also included in a Database Cluster 320, which house data for the respective engines indicated above. The Database Cluster includes a Business Partner Interaction Rules Database 360, an Entitlements Database 362, a Master Data Database 364, a Static Data Database 366, a Business Alerts Database 368, a Persistence Data Database 370, an Activity Log Database 372, and a Subscription Master Database 374.

The Tiered Web Services are supported by a Business Partner Interaction Rules Engine 338 and an Event Flow Manager 342. Here, a request for services such as multiple EMS partners manufacturing/assembly capacity or multiple component suppliers pricing/component availability can be triggered simultaneously and synchronously with persistency. The response is aggregated and served back to requestor of web services.

This one-to-many business process (of company A) to business process (of company B, C, D, and so on) level interaction is a unique capability. The business process level interaction is confined to the public portion of the process only (i.e., public portion of the business process is one which can be shared with business partners through web services, and the private portion of the business process is one which is insulated from the business partners, for example: how an organization internally projects the availability of components or pricing for one customer vs. Others).

According to the present invention, a Tiered Web Service Splitter-Aggregator may be used by a business partner and service type (business process-function). For example, a distributor (Company A) requests pricing and availability from multiple OEM partners (Company B, C, D-splitting) and receives an aggregated response in real-time with product availability and pricing from OEM partners. In a different scenario, an OEM (Company A) requests the availability of components from suppliers (Company B, C, D) and manufacturing/assembly capacity from contract manufacturers (Company X and Y), receives an aggregated real-time response for pricing, the availability and manufacturing/assembly capacity (different business processes-functions, different business partners) to get a composite (aggregated) value-chain based view. The splitter-aggregator rules are maintained in the private exchange for web services.

The Three-way Entitlement Engine 336 works in the following manner. The web services are brokered through a private exchange based on the three-way entitlements for the service. The three-way entitlements verify the requesting organization, systems/individual service type requested and matches with what the service provider(s) has authorized. For example, Company A is a contract manufacturer, Company B is a component/raw material supplier to Company C through Company A, and Company C is the OEM customer. Company C and systems/individuals requesting service from Company A and B must be authorized to access web services provided by Company A (manufacturing/assembly capacity) and B (availability/pricing of only the component/raw materials being supplied to Company C).

This plug and play entitlement engine binds the organizations, individuals, business processes, and information resources (for example; part numbers, pricing, etc. could be accessed by one partner but not by the other partner, etc.) thereby eliminating the need to embed complex business rules in the coding of software programs. This feature augments most LDAP tools by providing capabilities to grant entitlements at a very granular level.

The Multi-way Entitlement System provides for three entitlements: relational entitlement, pass-thru entitlement, and resource entitlement. For example, in the relational entitlement, in one particular scenario, Company A may be a customer of Company B, whereas in a different business scenario, Company A may be a supplier to Company B. In each case, the entitlement for Company A is different based on the business process and the role of that company in the context of the given business process. The dynamic transparency is constantly maintained between different business partners in the value chain with the ability to maintain relational entitlements continuously.

In the pass-thru entitlement, in one scenario, an OEM (Company A) may be able to check the availability of finished goods with a contract manufacturer (Company B), and subsequently check the dependency on the component supplier (Company C). Company B may have entitled Company D to check component availability and pricing with Company C, while restricting Company A from being able to do the same. The pass-thru entitlement does not have any bounds and can be extended to n number of partners in the value chain/business network based on how extensively the business process traverses with the value chain.

In the resource entitlement, for example, Company A may be able to check the availability and pricing of Company B's products, which Company A sells (for example, product x and y) and not any other products. However, Company A may be unable to request credit for products x and y. In one scenario, Company A may be able to order an unlimited quantity of product x, but may have restrictions on the quantity of product y which may be ordered. The resource entitlement can grant access privilege down to the information type, business process usage, and function.

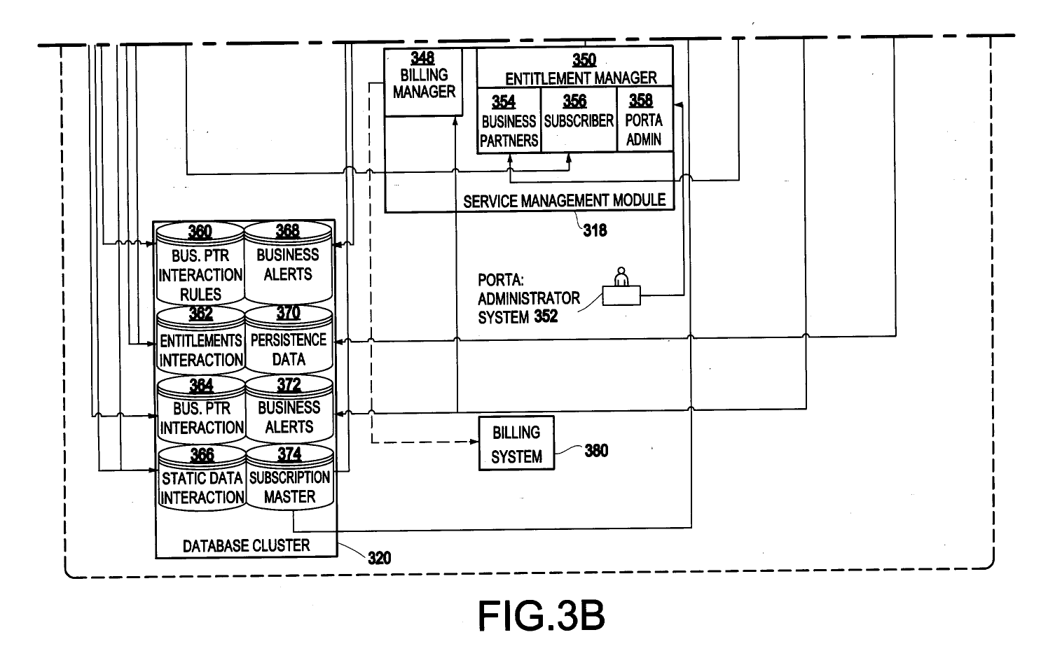

Additionally, there is provided, according to the present invention, a method for managing a one-to-many business process interaction using an on-demand supply chain management system among enterprises who are customers of and suppliers to each other, as illustrated in FIG. 4, wherein the method comprises making 400 requests for services on a web-based network to one or more enterprises, accessing 410 the web-based network services by other enterprises in accordance with a predefined relationship through a private exchange system, and fulfilling 420 the requests by one or more of the enterprises using an on-demand supply chain management system.

The on-demand supply chain management of the above method is operable through an Entitlement Engine 336 having a relational entitlement component, a pass-thru entitlement component linked to the relational entitlement component, and a resource entitlement component linked to the relational entitlement component, wherein the relational entitlement component parses data based on a predefined business process among the enterprises. Also, the pass-thru entitlement component parses data from one enterprise up to an n number of enterprises. Furthermore, the resource entitlement component parses data based on available resources of the enterprises. Additionally, the step of making requests 400 occurs simultaneously with other requests.

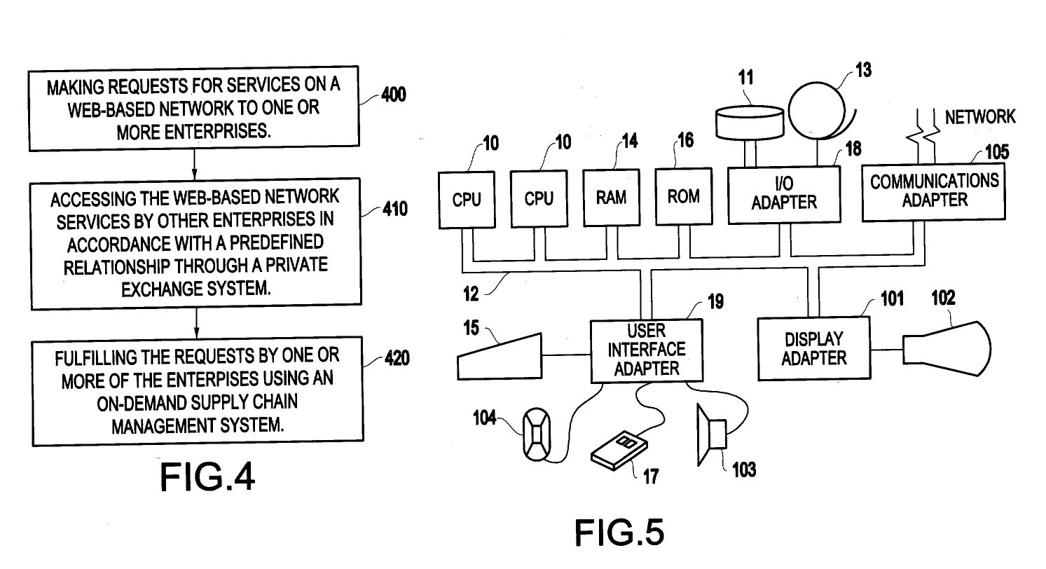

A representative hardware environment for practicing the present invention is depicted in FIG. 5 which illustrates a typical hardware configuration of an information handling/computer system 1 in accordance with the present invention, having at least one processor or central processing unit (CPU) 10. The CPUs 10 are interconnected via system bus 12 to random access memory (RAM) 14, read-only memory (ROM) 16, an input/output (I/O) adapter 18 for connecting pe ral devices, such as disk units 11 and tape drives 13, to bus 12, user interface adapter 19 for connecting keyboard 15, mouse 17, speaker 103, microphone 104, and/or other user interface devices such as a touch screen device (not shown) to bus 12, communication adapter 105 for connecting the information handling system to a data processing network, and display adapter 101 for connecting bus 12 to display device 102. A program storage device readable by the disk or tape units is used to load the instructions, which operate the invention, which is loaded onto the computer system 1.

There are several advantages of the present invention. Particularly, this type of on-demand supply chain management system is applicable to the entire supply chain, and it supports reduction in fulfillment lead times from several weeks down to a few days (more than 50%) as it is not necessary to locate component suppliers. The present invention also enhances supply-chain visibility and spot-pricing in the field, as well as providing price protection for products with declining average selling price and shorter product life. Furthermore, the present invention provides price determination closer to delivery schedule, and provides normalization of demand and capacity without requiring over investments to increase the merely short-lived capacity demand. Moreover, the present invention provides a novel information management system utilizing an entitlement engine as well as web services to effectively manage a one-to-many business process interaction using an on-demand supply chain management system and approach.

While the invention has been described in terms of preferred embodiments, those skilled in the art will recognize that the invention can be practiced with modification within the spirit and scope of the appended claims.

What is claimed is:

1. A method for managing a one-to-many business process interaction using an on-demand supply chain management system among enterprises who are customers of and suppliers to each other, said method comprising:
making requests for services on an internet-based network to one or more said enterprises;
accessing said internet-based network services by other enterprises in accordance with a predefined relationship through a private exchange system; and
fulfilling said requests by one or more said enterprises using said on-demand supply chain management system,
wherein said on-demand supply chain management is operable through an entitlement engine.

2. The method of claim 1, wherein said entitlement engine comprises:
a relational entitlement component;
a pass-thru entitlement component linked to said relational entitlement component; and
a resource entitlement component linked to said relational entitlement component.

3. The method of claim 2, wherein said relational entitlement component parses data based on a predefined business process among the enterprises.

4. The method of claim 2, wherein said pass-thru entitlement component parses data from one enterprise up to an n number of enterprises.

5. The method of claim 2, wherein said resource entitlement component parses data based on available resources of said enterprises.

6. The method of claim 1, wherein said step of making requests occurs simultaneously with other said requests.

7. An information management system configured to integrate a one-to-many business process interaction using on-demand supply chain management among enterprises who are customers of and suppliers to each, said system comprising:
an entitlement engine;
a web service aggregator; and
a private exchange network operable to link said entitlement engine with said web service aggregator.

8. The system of claim 7, wherein said entitlement engine comprises:
a relational entitlement component;
a pass-thru entitlement component linked to said relational entitlement component; and
a resource entitlement component linked to said relational entitlement component.

9. The system of claim 8, wherein said relational entitlement component parses data based on a predefined business process among the enterprises.

10. The system of claim 8, wherein said pass-thru entitlement component parses data from one enterprise up to an n number of enterprises.

11. The system of claim 8, wherein said resource entitlement component parses data based on available resources of said enterprises.

12. The system of claim 8, wherein said web service aggregator comprises rules, said rules maintained in said private exchange network.

13. The system of claim 7, further comprising:
a core module comprising said entitlement engine;
a communication module comprising said web services aggregator;
a data management module linked to said core module;
a transaction module linked to said core module;
a service management module linked to said core module; and
a database cluster linked to said data management module.

14. The system of claim 13, wherein said data management module comprises:
a data mapping and transformation component linked to said database cluster;
a cache manager linked to said database cluster; and
a broadcast manager linked to said communication module.

15. The system of claim 13, wherein said core module further comprises:
an enterprise interaction rules engine linked to said database cluster;
a business alert manager linked to said database cluster; and
an event flow manager linked to said enterprise interaction rules engine.

16. The system of claim 13, wherein said service management module further comprises:
a billing manager linked to said database cluster; and
an entitlement manager linked to said database cluster,
wherein said billing manager communicates with an external billing system.

17. The system of claim 13, wherein said transaction module further comprises:
a transaction audit component linked to said core module; and
a persistence manager linked to said core module.

18. A program storage device readable by machine, tangibly embodying a program of instructions executable by said machine to perform a method for managing a one-to-many business process interaction using on-demand supply chain management among enterprises who are customers of and suppliers to each other, said method comprising:
making requests for services on a web-based network to one or more said enterprises;
accessing said web-based network services by other enterprises in accordance with a predefined relationship through a private exchange system; and
fulfilling said requests by one or more said enterprises using said on-demand supply chain management
wherein said on-demand supply chain management is operable through an entitlement engine.

19. The program storage device of claim 18, wherein said entitlement engine comprises:
a relational entitlement component;
a pass-thru entitlement component linked to said relational entitlement component; and
a resource entitlement component linked to said relational entitlement component.

20. The program storage device of claim 19, wherein said relational entitlement component parses data based on a predefined business process among the enterprises.

21. The program storage device of claim 19, wherein said pass-thru entitlement component parses data from one enterprise up to an n number of enterprises.

22. The program storage device of claim 19, wherein said resource entitlement component parses data based on available resources of said enterprises.

23. The program storage device of claim 18, wherein said step of making requests occurs simultaneously with other said requests.
